(19) United States
(12) Patent Application Publication
(10) Pub. No.: US 2016/0329625 A1
(43) Pub. Date: Nov. 10, 2016

(54) WIRELESS COMMUNICATION DEVICE AND ANTENNA THEREOF

(71) Applicant: CHIUN MAI COMMUNICATION SYSTEMS, INC., New Taipei (TW)

(72) Inventor: YEN-HUI LIN, Tu-Cheng (TW)

(21) Appl. No.: 14/867,215

(22) Filed: Sep. 28, 2015

(30) Foreign Application Priority Data
May 9, 2015 (CN) 201510293689.6

(51) Int. Cl. H01Q 1/24; H01Q 5/335; H01Q 1/50

(52) U.S. Cl. CPC H01Q 1/243; H01Q 1/50; H01Q 5/335

(57) ABSTRACT

A wireless communication device includes a housing and an antenna. The housing has a first end portion and a second end portion opposite the first end portion and defining a slot adjacent to the first end portion. The slot divides the housing into an antenna portion and a housing portion. The antenna is coupled to the housing and includes the antenna portion, a feed end, a ground end, and an adjusting circuit. The ground end is received in the slot and connected between the antenna portion and the housing portion. The adjusting circuit is connected to the antenna portion by an adjusting point whereby the antenna portion is configured to operate in a first working frequency band and a second working frequency band.

### FIELD

The subject matter herein generally relates to antennas, particularly to a wireless communication device having a metallic appearance and an antenna thereof.

### BACKGROUND

Performances such as CPU processing speed, camera pixel, resolution and sensitivity of a touch panel of a wireless communication device are continuously improved to satisfy increasing requirements of users. At the same time, an appearance of the wireless communication device trends towards metallization and miniaturization.

### BRIEF DESCRIPTION OF THE DRAWINGS

Implementations of the present technology will now be described, by way of example only, with reference to the attached figures.

FIG. 1 is an isometric view of a wireless communication device, according to an exemplary embodiment.

FIG. 2 is an isometric view of an antenna of a wireless communication device, according to a first embodiment.

FIG. 3 is similar to FIG. 2, but shown from another angle.

FIG. 4 is a circuit diagram of an adjusting circuit of the antenna of FIG. 2.

FIG. 5 is a circuit diagram of an impedance matching circuit of the antenna of FIG. 2.

FIG. 6 is a graph illustrating return loss varying with frequency of the antenna of FIG. 2.

FIG. 7 is a graph illustrating radiation efficiency varying with frequency of the antenna of FIG. 2.

FIG. 8 is a graph illustrating return loss varying with frequency of the antenna of FIG. 2, when an inductance of a matching inductor is 0 nH, 5 nH, and 7.5 nH.

FIG. 9 is a graph illustrating radiation efficiency varying with frequency of the antenna of FIG. 2, when an inductance of a matching inductor is 0 nH, 5 nH, and 7.5 nH.

FIG. 10 is an isometric view of an antenna, according to a second embodiment.

FIG. 11 is a graph illustrating return loss varying with frequency of the antenna of FIG. 10.

FIG. 12 is a graph illustrating radiation efficiency varying with frequency of the antenna of FIG. 10.

FIG. 13 is a circuit diagram of an adjusting circuit of an antenna, according to a third embodiment.

FIG. 14 is a graph illustrating return loss varying with frequency of the antenna of FIG. 13.

FIG. 15 is a graph illustrating radiation efficiency varying with frequency of the antenna of FIG. 13.

FIG. 16 is an isometric view of a wireless communication device, according to another exemplary embodiment.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “substantially” is defined to be essentially conforming to the particular dimension, shape, or other feature that the term modifies, such that the component need not be exact. For example, “substantially cylindrical” means that the object resembles a cylinder, but can have one or more deviations from a true cylinder. The term “comprising,” when utilized, means “including, but not necessarily limited to”; it specifically indicates open-ended inclusion or membership in the so-described combination, group, series and the like.

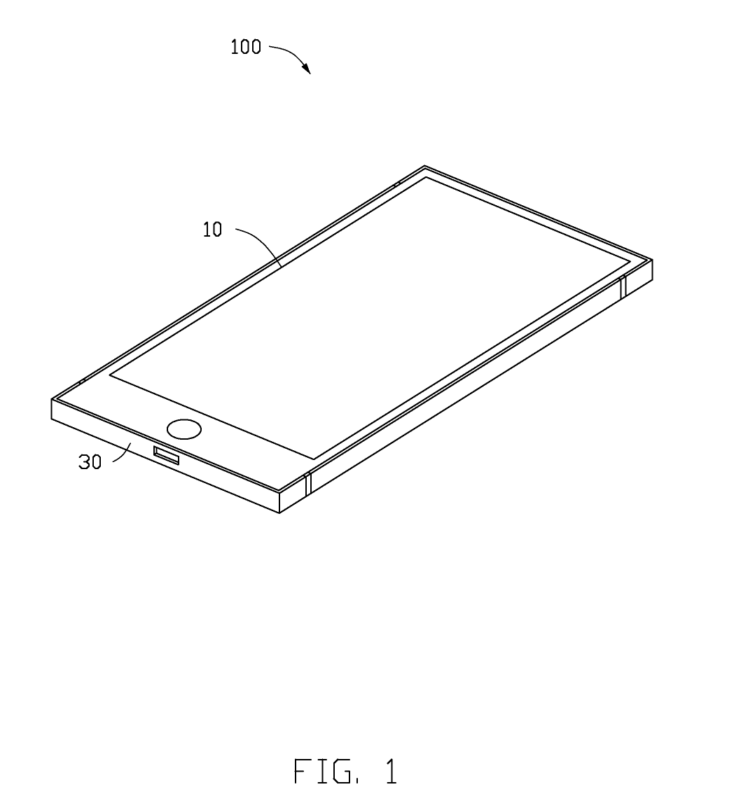

FIG. 1 illustrates an isometric view of a wireless communication device 100, according to an exemplary embodiment. The wireless communication device 100 can be, but not limited to, a mobile phone, a personal digital assistant (PDA), and a tablet personal computer. In this exemplary embodiment, the wireless communication device 100 is a mobile phone.

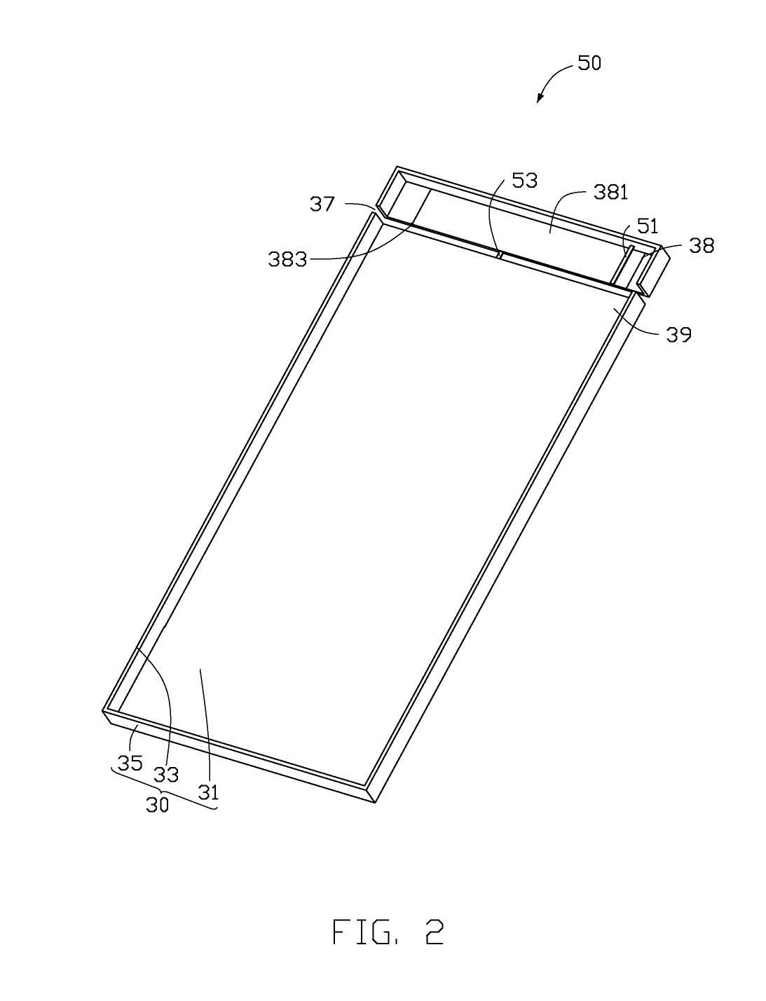

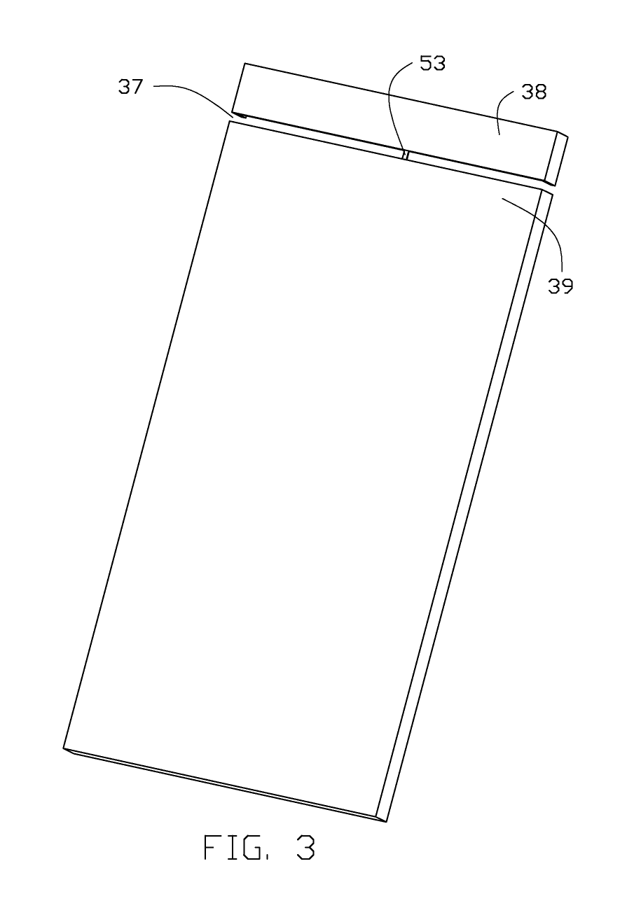

FIGS. 2 and 3 illustrate that the wireless communication device 100 includes a cover 10, a housing 30, and antenna 50. The cover 10 and the housing 30 are outer shells of the wireless communication device 100, can be a front shell and a back shell of the wireless communication device 100. A display and a main key are positioned on a surface of the cover 10. The housing 30 is made of metal. The housing 30 includes a base 31, two opposite side walls 33, and two opposite end portions 35. The base 31 is substantially rectangular. The two side walls 33 and the two opposite end portions 35 are alternatively surrounded edges of the base 31. A slot 37 is defined in the housing 30 adjacent to an end of the housing 30. The slot 37 divides the housing 30 into an antenna portion 38 and a housing portion 39. In the illustrated embodiment, the slot 37 is substantially U-shaped and is defined in the base 31 and the two side walls 33 running through an outer surface and an inner surface of the base 31 and the two side walls 33. To ensure an integrity of appearance of the housing 30, insulating material such as plastics, glass, ceramics can be filled into the slot 37.

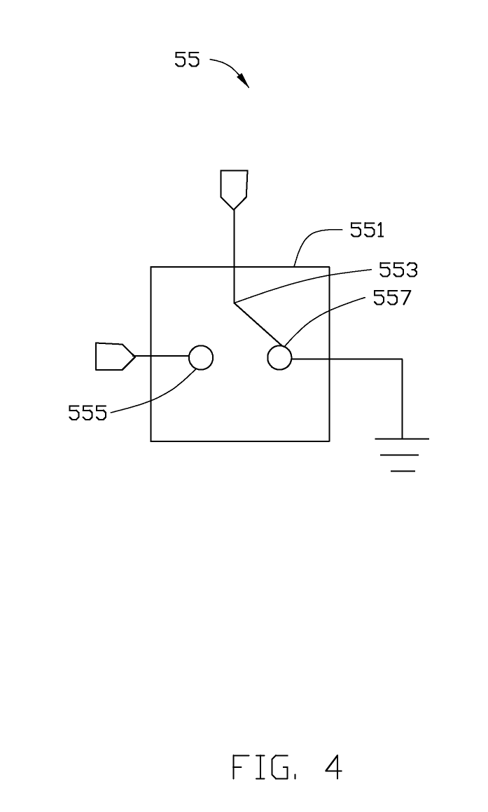

FIG. 4 illustrates that the antenna 50 includes the above-described antenna portion 38, a feed end 51, a ground end 53, an adjusting circuit 55.

A keep-out-zone 381 is defined in the antenna portion 38. The purpose of the keep-out-zone 381 is to delineate an area on the antenna portion 38 in which other electronic components (such as a camera, a vibrator, a speaker, etc.) cannot be placed. In at least one embodiment, the keep-out-zones 381 is disposed on the end of base 31.

An adjusting point 383 is disposed on the antenna portion 38 adjacent to the slot 37 and one of the side walls 33. The adjusting point 383 is configured for connecting to the adjusting circuit 55. The feed end 51 is substantially strip-shaped, positioned in the keep-out-zone 381 and adjacent the other side walls 33, and perpendicular to the slot 37. The feed end 51 is configured for accessing to feed current to the antenna portion 38. The ground end 53 (Shown in FIG. 2) is a strip-shaped conductive member. One end of the ground end 53 is connected to the antenna portion 38. Another end of the ground end 53 is connected to the housing portion 39. The ground end 53 is configured for grounding. The ground end 53 can be received in the slot 37 and positioned between the adjusting point 383 and the feed end 51.

In this exemplary embodiment, the adjusting circuit 55 is a switch circuit configured for switching the antenna portion 38 between an open circuit state and a short circuit state. The switch circuit includes a radio frequency (RF) switch 551. The RF switch 551 includes a connecting contact 553, a first switch contact 555, and a second switch contact 557. The connecting contact 553 is electrically connected to the adjusting point. The first switch contact 555 is floating. The second switch contact 557 is grounded. When the connecting contact 553 is switched to the first switch contact 555, the antenna portion 38 is in the open circuit state and can operate in a first working frequency band. In this exemplary embodiment, the first working frequency band is about 700 MHz-960 MHz. When the contacting contact is switched to the second switch contact 557, the antenna portion 38 is in the short circuit state and can operate in a second working frequency band. In this exemplary embodiment, the second working frequency band is about 1450 MHz-2400 MHz.

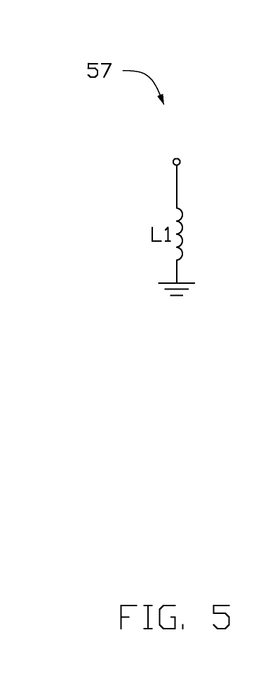

FIG. 5 illustrates that if the impedance of the antenna 50 needs to be matched, the antenna 50 further includes an impedance matching circuit 57. The impedance matching circuit 57 includes a matching inductor L1 configured for adjusting the impedance match of the antenna 50 to optimize the performance of antenna 50. The impedance matching circuit 57 can replace the ground end 53 to connect the antenna portion 38 and the housing portion 39. In this exemplary embodiment, an inductance of the matching inductor L1 7.5 nH. The impedance matching circuit 57 is positioned in the slot 37. In this exemplary embodiment, the impedance matching circuit 57 is positioned in the slot 37 by a flexible printed circuit. The impedance matching circuit 57 is received in the slot 37 and connected between the antenna portion 38 and the housing portion 39. In other exemplary embodiment, the impedance matching circuit 57 can be a capacitor or another different impedance matching circuit.

When the antenna 50 is used to transmit and/or receive signals, the connecting contact 553 of the adjusting circuit 55 can be switched to connect to the first switch contact 555, that is the antenna portion 38 is switched to the open circuit state under a control of a processor of the wireless communication device 100, the antenna portion 38 generates a first mode and the antenna 50 operates efficiently within a first working frequency band by adjusting the inductance of the matching inductor L1. In this exemplary embodiment, the first working frequency band is a low frequency band.

The connecting contact 553 of the adjusting circuit 55 can also be switched to connect to the second switch contact 557. For example, the antenna portion 38 is switched to the short circuit state, and the matching inductor L1 resonates with the slot 37 so that the antenna portion 38 generates a second mode, which makes the antenna 50 operate efficiently within a second working frequency band thereby widening a bandwidth of the antenna 50. In this exemplary embodiment, the second working frequency band is a high frequency band.

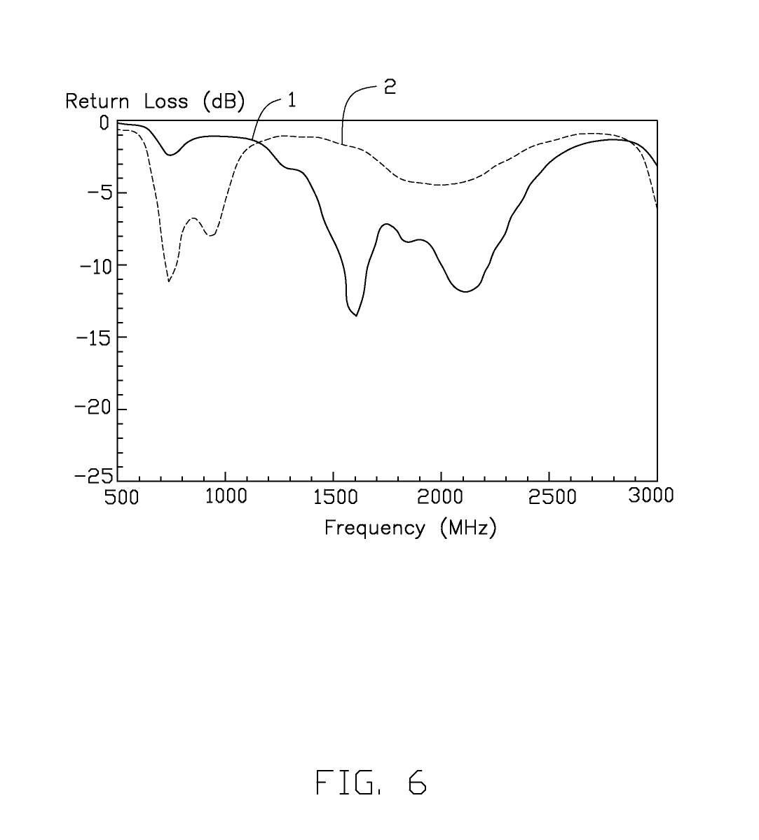

FIG. 6 illustrates that, curves 1, 2 respectively represent return losses of the antenna 50 in the short circuit state and the open circuit state. According to test results, the antenna 50 can operate efficiently within the first working frequency band about 700 MHz-960 MHz in the open circuit state and operate efficiently within the second working frequency band about 1450 MHz-2400 MHz in the short circuit state.

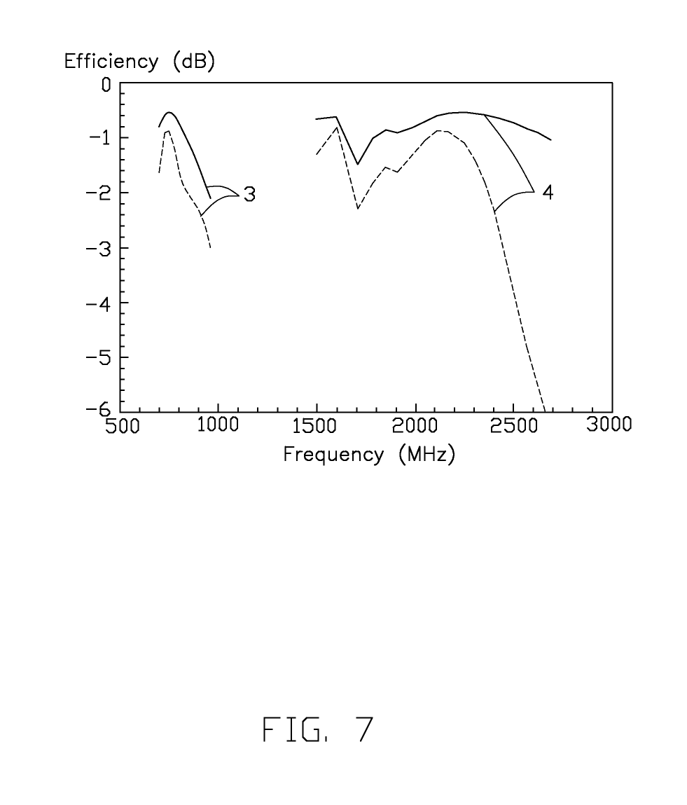

FIG. 7 illustrates that, curves 3, 4 respectively represent efficiencies of the antenna 50 in the short circuit state and the open circuit state, wherein, broken lines represent total efficiencies, and full lines represent radiation efficiencies. According to test results, the antenna 50 can have a better signal transmission and receiving performance in both open and short circuit states.

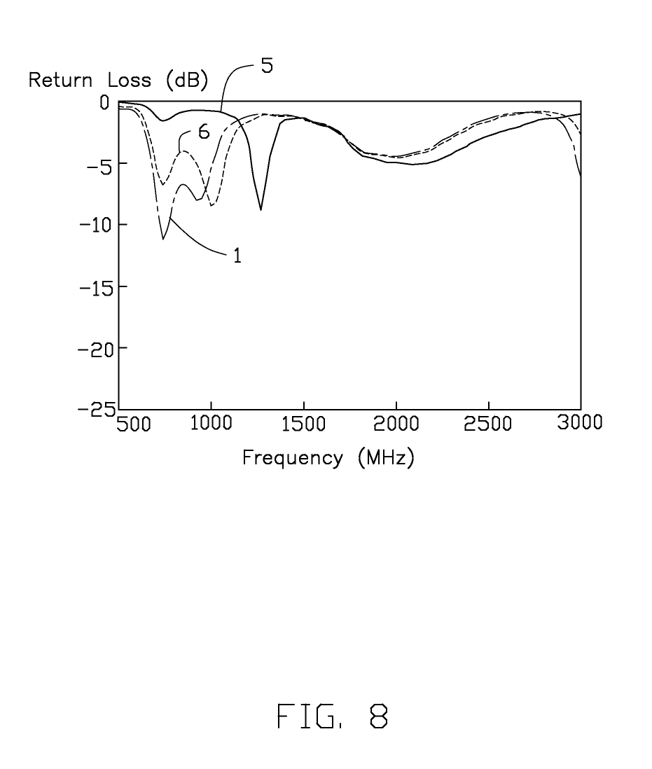

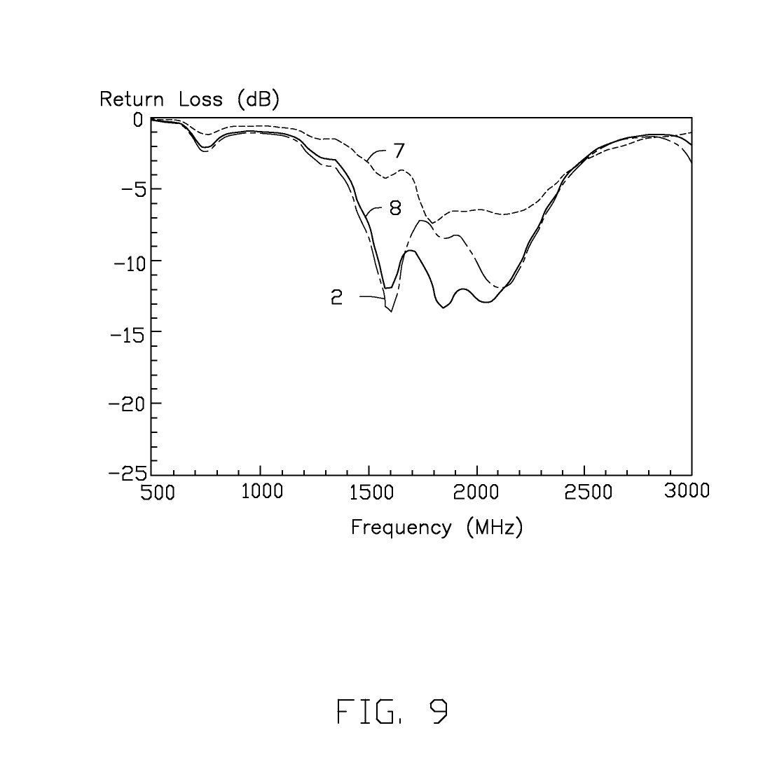

In other exemplary embodiment, the inductance of the matching inductor L1 can be changed. FIGS. 8 and 9 illustrate that, curves 5, 6, and 1 respectively represent return losses of the antenna 50 in the open circuit state when the inductance of the matching inductor L1 are respectively 0 nH, 5 nH, and 7.5 nH. Curves 7, 8, and 2 respectively represent return losses of the antenna 50 in the short circuit state when the inductance of the matching inductor L1 are respectively 0 nH, 5 nH, and 7.5 nH. According to test results, the first and second working frequency bands of the antenna 50 can be slightly adjusted by changing the inductance of the matching inductor L1.

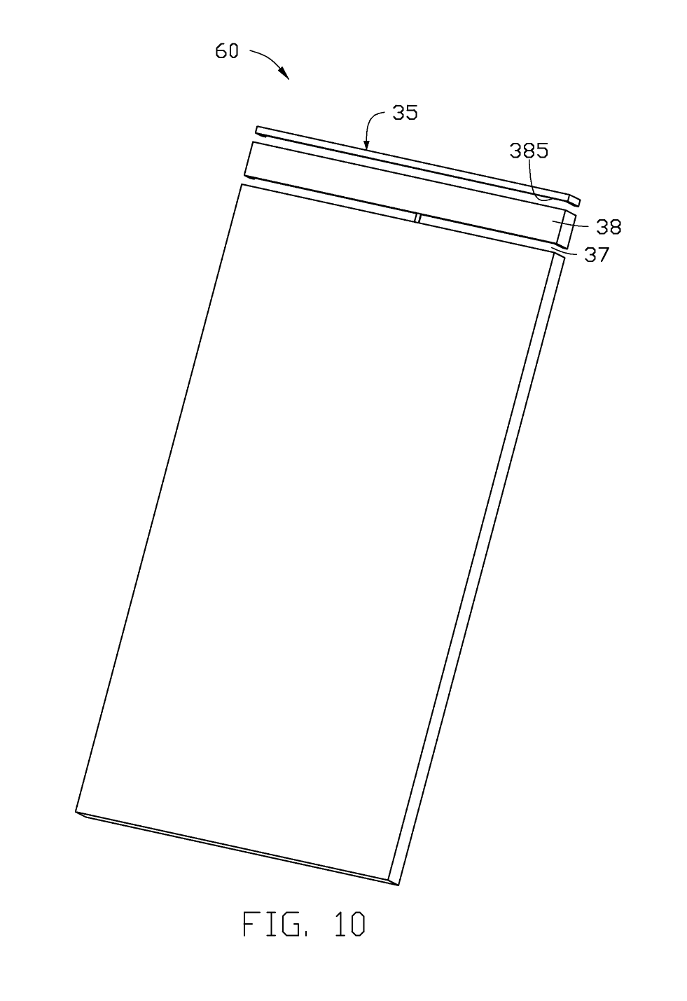

FIG. 10 illustrates an isometric view of an antenna 60, according to a second exemplary embodiment. A structure of an antenna 60 is substantially similar to that of the antenna 50. The difference is that the antenna portion 38 of the antenna 60 further includes at least one gap 385. The slot 37 and one of the end portion 35 define the at least one gap 385. A structure of the at least one gap 385 is substantially similar to that of the slot 37, and a width of the at least one gap 385 is slightly narrower than that of the slot 37. In this exemplary embodiment, there is one gap 385. In other exemplary embodiment, there can be two or more gaps 385.

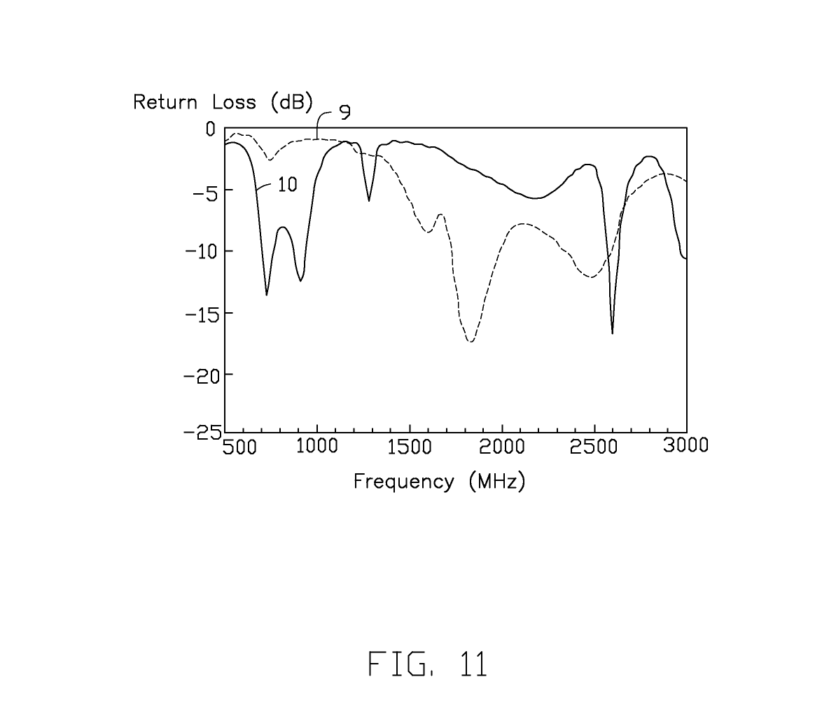

FIG. 11 illustrates that, curves 9, 10 respectively represent return losses of the antenna 60 in the short circuit state and the open circuit state. According to test results, operating principle of the antenna 60 is substantially similar to that of the antenna 50. When the antenna 60 is in the open circuit state, the antenna 60 can operate efficiently within the first working frequency band about 700 MHz-960 MHz by adjusting the inductance of the matching inductor L1. When the antenna 60 is in the short circuit state, the matching inductor L1 resonates with the slot 37 so that the antenna portion 38 generates the second mode, which makes the antenna 60 can operate efficiently within the second working frequency band about 1450-2690 MH. The gaps 385 are configured for slightly adjusting a bandwidth of the first and second working frequency bands.

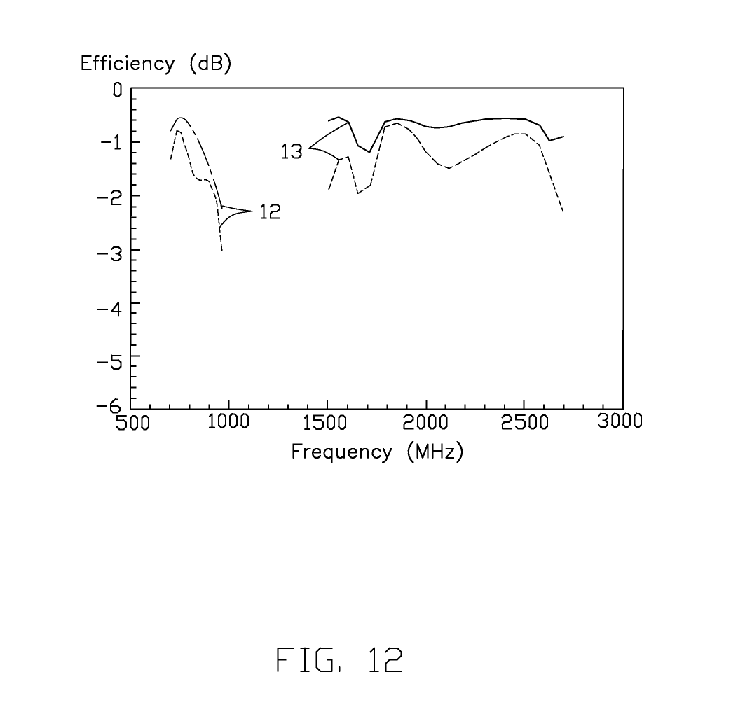

FIG. 12 illustrates that, curves 12, 13 respectively represent efficiencies of the antenna 60 in the short circuit state and the open circuit state, wherein, broken lines represent total efficiencies, and full lines represent radiation efficiencies. According to test results, the antenna 60 can have a better signal transmission and receiving performance in both open and short circuit states.

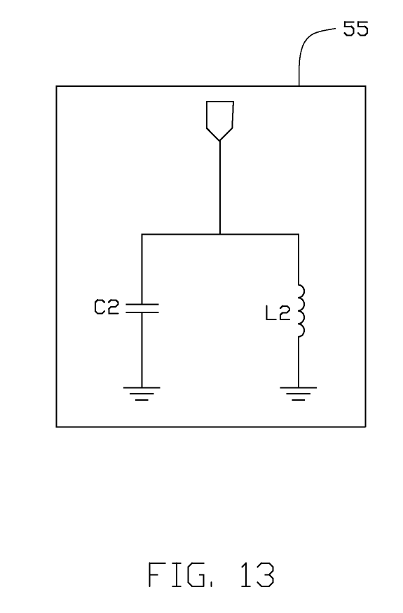

FIG. 13 illustrates that a circuit diagram of an adjusting circuit 55 of an antenna, according to a third exemplary embodiment. A structure of the antenna is substantially similar to that of the antenna 50. The difference is that the adjusting circuit 55 of the antenna, according to the third exemplary embodiment is a filter. The filter can be a band rejection filter or a high pass filter. The filter includes a filtering inductor L2 and filtering capacitor C2. The filtering inductor L2 and the filtering capacitor C2 are connected between the adjusting point 383 and ground in parallel. The filter appears an open character, which is similar to the open circuit state of the switch circuit in a low frequency band, and appears a short character, which is similar to the short circuit state of the switch circuit in a high frequency band. Therefore, the filter makes the antenna according to the third exemplary embodiment can both operate efficiently within the first and second working frequency bands.

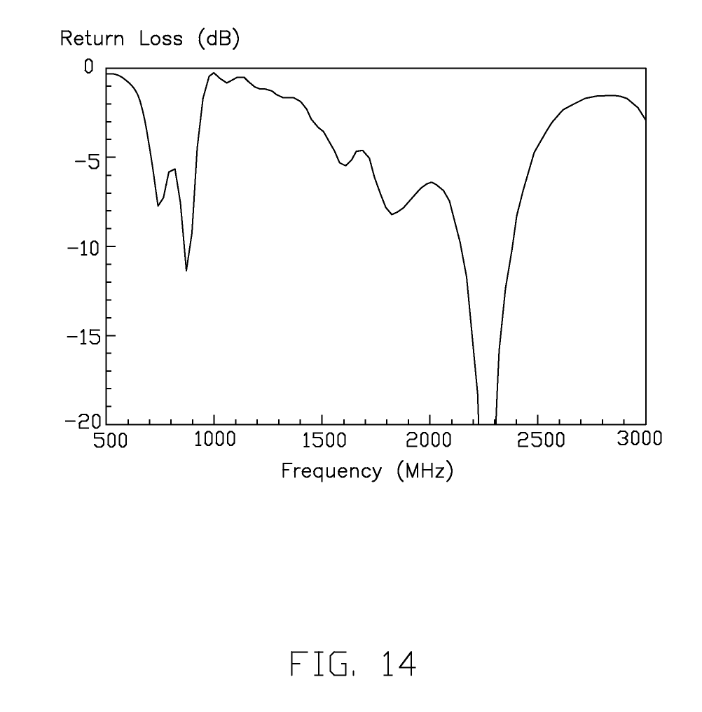

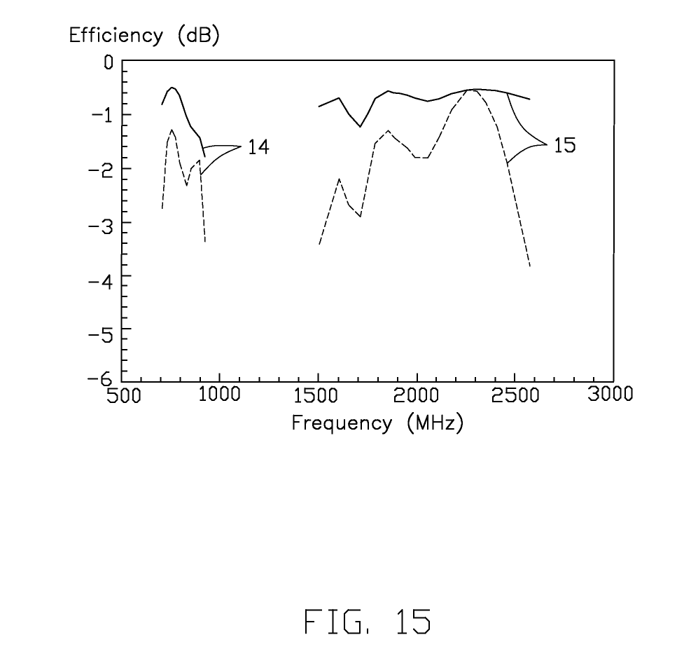

FIG. 14 illustrates that, according to test results, the antenna of the third exemplary embodiment can both operate efficiently within the first working frequency band about 700 MHz-960 MHz and the second working frequency band about 1450 MHz-2400 MHz. FIG. 15 illustrates that curves 14, 15 respectively represent efficiencies of the antenna of the third exemplary embodiment operating in the first working frequency band and the second working frequency band, wherein, broken lines represent total efficiencies, and full lines represent radiation efficiencies. According to test results, the antenna of the third exemplary embodiment can have a better signal transmission and receiving performance in both open and short circuit states.

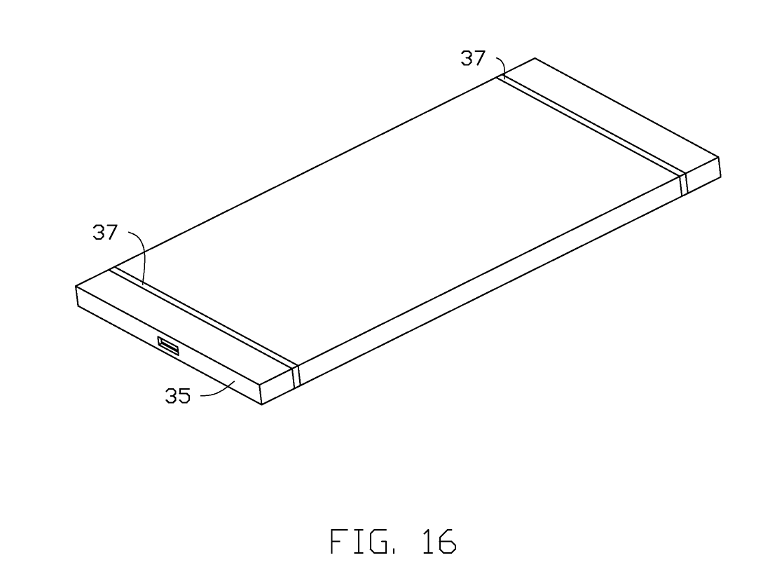

FIG. 16 illustrates that, in other exemplary embodiment, another slot 37 or one or more gaps 385 can be defined adjacent to the other end portion 35 of the wireless communication device to form the above-described antenna.

The antenna portion 38 of the antenna is formed by a portion of the housing 30 so that the antenna itself is integrated with the housing 30 The arrangement as illustrated is advantageous to miniaturization of the wireless communication device 1 as the antenna portion 38 occupies a small amount of space. In addition, because the antenna portion 38 is exposed to the outside, the antenna cannot be easily interfered by other elements inside the wireless communication device 100 and has a relative stable working performance.

It is to be understood, however, that even through numerous characteristics and advantages of the present disclosure have been set forth in the foregoing description, together with details of assembly and function, the disclosure is illustrative only, and changes may be made in the details, especially in the matters of shape, size, and arrangement of parts within the principles of the disclosure to the full extent indicated by the broad general meaning of the terms in which the appended claims are expressed.

What is claimed is:

1. A wireless communication device comprising:
a housing defining a slot dividing the housing into an antenna portion and a housing portion;
an antenna comprising the antenna portion and further comprising:
a feed end;
a ground end received in the slot and connected between the antenna portion and the housing portion; and
an adjusting circuit connected to the antenna portion by an adjusting point whereby the antenna portion is configured to operate in a first working frequency band and a second working frequency band.

2. The wireless communication device of claim 1, wherein the adjusting circuit is a switch circuit comprising a radio frequency (RF) switch, the RF switch comprises a connecting contact, a first switch contact, and a second switch contact, the connecting contact is electrically connected to the adjusting point, the first switch contact is floating, the second switch contact is grounded; when the connecting contact is switched to the first switch contact, the antenna portion is in an open circuit state and operates in the first working frequency band; when the contacting contact is switched to the second switch contact, the antenna portion is in a short circuit state and operates in the second working frequency band.

3. The wireless communication device of claim 1, wherein the antenna further comprises at least one gap defined between the slot and an end portion of the housing.

4. The wireless communication device of claim 1, wherein the adjusting circuit is a filter, the filter comprises a filtering inductor and a filtering capacitor; the filtering inductor and the filtering capacitor are connected between the adjusting point and a ground in parallel.

5. The wireless communication device of claim 4, wherein the filter is one of a band rejection filter and a high pass filter.

6. The wireless communication device of claim 1, wherein the antenna further comprises an impedance matching circuit positioned in the slot and connected between the antenna portion and the housing portion to replace the ground end.

7. The wireless communication device of claim 6, wherein the impedance matching circuit is one of an inductor and a capacitor.

8. The wireless communication device of claim 1, wherein the housing comprises a first end portion and a second end portion opposite to the first end portion, the slot is adjacent to the first end portion, the wireless communication device further comprises another slot defined in the housing and adjacent to the second end portion of the housing to form the antenna.

9. An antenna used in a wireless communication device comprising a housing, the antenna comprising:
an antenna portion, the housing defining a slot that divides the housing into the antenna portion and a housing portion;
a feed end;
a ground end received in the slot and connected between the antenna portion and the housing portion; and
an adjusting circuit connected to the antenna portion by an adjusting point to make the antenna portion capable of operating in a first working frequency band and a second working frequency band.

10. The antenna of claim 9, wherein the adjusting circuit is a switch circuit comprising a radio frequency (RF) switch, the RF switch comprises a connecting contact, a first switch contact, and a second switch contact, the connecting contact is electrically connected to the adjusting point, the first switch contact is floating, the second switch contact is grounded; when the connecting contact is switched to the first switch contact, the antenna portion is in an open circuit state and operates in the first working frequency band; when the contacting contact is switched to the second switch contact, the antenna portion is in a short circuit state and operates in the second working frequency band.

11. The antenna of claim 9, wherein the antenna further comprises at least one gap defined between the slot and an end portion of the housing.

12. The antenna of claim 9, wherein the adjusting circuit is a filter, the filter comprises a filtering inductor and a filtering capacitor; the filtering inductor and the filtering capacitor are connected between the adjusting point and a ground in parallel.

13. The antenna of claim 12, wherein the filter is one of a band rejection filter and a high pass filter.

14. The antenna of claim 9, further comprising an impedance matching circuit positioned in the slot and connected between the antenna portion and the housing portion to replace the ground end.

15. The antenna of claim 14, wherein the impedance matching circuit is one of an inductor and a capacitor.

16. The antenna of claim 9, wherein the housing comprises a first end portion and a second end portion opposite to the first end portion, the slot is adjacent to the first end portion, the wireless communication device further comprises another slot defined in the housing and adjacent to the second end portion of the housing to form the antenna.
